(19) United States
(12) Patent Application Publication
(10) Pub. No.: US 2026/0012732 A1
(43) Pub. Date: Jan. 8, 2026

(54) VEHICLE-MOUNTED LOUDSPEAKER

(71) Applicant: ALPS ALPINE CO., LTD., Tokyo (JP)

(72) Inventor: Ryo ITO, Fukushima (JP)

(21) Appl. No.: 19/214,642

(22) Filed: May 21, 2025

(30) Foreign Application Priority Data
Jul. 3, 2024 (JP) 2024-107121

(51) Int. Cl. H04R 7/12; H04R 1/02

(52) U.S. Cl. CPC H04R 7/12; H04R 1/02; H04R 2499/13

(57) ABSTRACT

A vehicle-mounted loudspeaker capable of reducing a load mass acting on a diaphragm, even with reduction in the volume of a back space of a case, is provided. A case has a flat region and a tapered region on the periphery of the flat region. The centroid of the flat region is set at a position closer to a duct than the center line of vibration of the diaphragm is. The width dimension of the tapered region when seen in a plane is larger at positions apart from the duct and narrower at positions closer to the duct along circumferential loci. As a result, the back space in the case gradually widens from the position apart from the duct toward the duct along the circumferential loci.

### CROSS-REFERENCE TO RELATED APPLICATION

The present application claims priority under 35 U.S.C. § 119 to Japanese Patent Application No. 2024-107121, filed Jul. 3 2024, the contents of which are incorporated herein by reference in their entireties.

### BACKGROUND OF THE INVENTION

### Field of the Invention

The present disclosure relates to a vehicle-mounted loudspeaker in which a diaphragm and a magnetic drive part are housed in a case having a duct.

### Description of the Related Art

Japanese Patent Application Laid-Open Publications No. 2013-118585 and 2019-125962, describe vehicle-mounted loudspeakers used as what are generally referred to as subwoofers or the like. In these vehicle-mounted loudspeakers, a sounding unit composed of a diaphragm and a magnetic drive part is provided in a case. A duct is integrally formed on the case to guide sound pressure generated when the diaphragm vibrates to outside the case, and a sounding port is opened in the duct. The case including the diaphragm is installed in an exterior space of a vehicle, and the duct is attached to a hole formed in a partition wall of the vehicle, such that sound pressure generated in the case in response to the vibration of the diaphragm is applied as a reproduced sound into the interior space of the vehicle through the sounding port of the duct.

### SUMMARY OF THE INVENTION

In both of the vehicle-mounted loudspeakers described in Japanese Patent Application Laid-Open Publications No. 2013-118585 and 2019-125962, sound pressure to become a reproduced sound is applied into the interior space of the vehicle through the sounding port of the duct. Here, depending on the structure and the size of the vehicle, there is also a method of using a vehicle-mounted loudspeaker having almost the same structure as described in Japanese Patent Application Laid-Open Publications No. 2013-118585 and 2019-125962, by installing the case in the interior space of the vehicle, opening the duct to the exterior space, and making the diaphragm in the case apply sound pressure into the interior space of the vehicle. In this case, the vibration characteristics of the diaphragm have a direct relation with the sound output sensitivity.

The case having the duct operates as a Helmholtz resonator. Around the resonance frequency of the Helmholtz resonator, the resonance of air in the duct increases the inner pressure in the case, leading to a phenomenon that the amplitude of the diaphragm is greatly limited. Here, although the sound pressure is continuously output to an exterior space from the duct, the output as sound pressure applied into the interior space of the vehicle by the diaphragm is significantly reduced since the amplitude of the diaphragm is limited. This type of a vehicle-mounted loudspeaker is used as a woofer, and the frequency band of use is approximately 150 Hz at the maximum. Therefore, in order to increase the output sensitivity of the diaphragm in the frequency band of use, it is necessary to set the resonance frequency of the Helmholtz resonator to be higher than 150 Hz. Although it is possible to set the resonance frequency to be higher by making the duct thicker and shorter, it is impossible to increase the opening diameter of the duct unconditionally due to the constraints on the vehicle side. In addition, when the duct is thick and short, there is a concern about the intrusion of foreign matter, dust, and the like from outside of the vehicle.

Therefore, in order to increase the resonance frequency of the Helmholtz resonator, it is necessary to make the case smaller and reduce the inner volume of the back space between the inner wall surface of the case and the diaphragm. However, when the inner volume is reduced, the counter distance between the inner wall surface of the case and the diaphragm is shortened, thereby increasing a resistive load (local pressure), which is a resistance against air flow from the back space to the duct, when the diaphragm vibrates. This resistive load substantially increases the acoustic resistive load in the duct. As a result, the load acting on the diaphragm increases, to restrict the movement of the diaphragm in the frequency band of use, leading to a problem that the output sensitivity for low-tone sounds is reduced. An object of the present disclosure is to solve the conventional problem described above and to provide a vehicle-mounted loudspeaker having a structure capable of reducing an acoustic resistive load moving from a back space between an inner wall surface of a case and a diaphragm toward a duct when the diaphragm vibrates.

A vehicle-mounted loudspeaker of the present disclosure includes: a case having a duct; a diaphragm; and a magnetic drive part configured to drive the diaphragm, the diaphragm and the magnetic drive part being installed inside the case. The diaphragm has an outer surface that applies sound pressure to outside the case and an inner surface facing an interior of the case. The diaphragm includes a tapered part tapering inward in the case toward a center line of vibration extending in a vibration direction while passing through a center line of the diaphragm.

A back space enclosed by the inner surface of the diaphragm and an inner wall surface of the case and leading to an interior of the duct is formed inside the case.

When a cross-section including the center line of vibration and a center of an opening of the duct is defined as a longitudinal cross-section, and a cross-section including the center line of vibration and orthogonal to the longitudinal cross-section is defined as a transverse cross-section, an area of a space in which the tapered part and the inner wall surface face each other is larger when seen in the transverse cross-section than when seen in the longitudinal cross-section, the space being a space at a position opposite to a location of the duct with respect to the center line of vibration in the longitudinal cross-section, and the space being a space at a position on a path along a circular circumference centering on the center line of vibration in the transverse cross-section.

In the vehicle-mounted loudspeaker of the present disclosure, it is preferable that the area when seen in cross-sections including the center line of vibration at respective positions on the path along the circular circumference centering on the center line of vibration gradually increases from the position in the longitudinal cross-section toward the position on the path in the transverse cross-section.

In the vehicle-mounted loudspeaker of the present disclosure, it is preferable that the area when seen in the cross-sections including the center line of vibration at the respective positions on the path along the circular circumference centering on the center line of vibration gradually increases from the position on the path in the transverse cross-section toward a boundary between the case and the duct.

The vehicle-mounted loudspeaker of the present disclosure can be configured such that an opening angle between the inner surface of the tapered part and the inner wall surface of the case is larger when seen in the transverse cross-section than when seen in the longitudinal cross-section, the opening angle being the opening angle at the position opposite to the location of the duct with respect to the center line of vibration in the longitudinal cross-section, and the opening angle being an opening angle at the position on the path along the circular circumference centering on the center line of vibration in the transverse cross-section.

In the vehicle-mounted loudspeaker of the present disclosure, it is preferable that the opening angle when seen in the cross-sections including the center line of vibration at the respective positions on the path along the circular circumference centering on the center line of vibration gradually increases from the position in the longitudinal cross-section toward the position on the path in the transverse cross-section.

In the vehicle-mounted loudspeaker of the present disclosure, it is preferable that the opening angle when seen in the cross-sections including the center line of vibration at the respective positions on the path along the circular circumference centering on the center line of vibration gradually increases from the position on the path in the transverse cross-section toward the boundary between the case and the duct.

In the vehicle-mounted loudspeaker of the present disclosure, the inner wall surface of the case includes: a flat inner wall surface orthogonal to the center line of vibration and facing the inner surface of the diaphragm; and a tapered inner wall surface positioned on an outer periphery of the flat inner wall surface and inclined in a same direction as a direction in which the tapered part is inclined.

A width dimension of the tapered inner wall surface when seen in a plane orthogonal to the center line of vibration can be configured to be smaller at the position on the path in the transverse cross-section than at the position in the longitudinal cross-section.

In the vehicle-mounted loudspeaker of the present disclosure, it is preferable that the width dimension gradually decreases along the path along the circular circumference centering on the center line of vibration from the position in the longitudinal cross-section toward the position on the path in the transverse cross-section.

In the vehicle-mounted loudspeaker of the present disclosure, it is preferable that the width dimension gradually decreases along the path along the circular circumference from the position on the path in the transverse cross-section toward the boundary between the case and the duct.

In the vehicle-mounted loudspeaker of the present disclosure, a centroid of the flat inner wall surface when seen in the plane can be located closer to the duct than the center line of vibration is.

For example, in the vehicle-mounted loudspeaker of the present disclosure, the duct is opened to an exterior space bounded by a partition wall, and sound pressure is applied by the diaphragm to an interior space bounded by the partition wall.

In a vehicle-mounted loudspeaker using a case having a duct, air moving in the duct acts as a load mass when the diaphragm vibrates. Here, because the back space communicates with the duct having a smaller inner volume than that of the back space, when the diaphragm vibrates, the resistance against air flow from a position in the back space that is farthest from the duct toward the duct is substantially added to the load mass in the duct. When the load mass increases, the vibration of the diaphragm is restricted, thereby reducing the output. Therefore, the present disclosure reduces the resistance (local pressure) related to air flow moving in the back space toward the duct, by designing the area (volume) of the back space in each cross-section to increase from the position farthest from the duct along the path along the circular circumference.

When a case having a duct is used, the vibration of the diaphragm around the Helmholtz resonance frequency is restricted. Therefore, in a loudspeaker in which the duct is opened to an exterior space bounded by a partition wall and sound pressure is applied by the diaphragm to an interior space bounded by the partition wall, the sound pressure applied by the diaphragm to the interior of a vehicle around the Helmholtz resonance frequency is low. Therefore, in this loudspeaker, it is desirable to set the Helmholtz resonance frequency to be higher than the frequency band of use. Here, it is possible to set the Helmholtz resonance frequency in a high region by reducing the inner volume of the back space. Even in this case, the vehicle-mounted loudspeaker of the present disclosure can reduce the resistive load related to air flow in the back space, making it possible to restrict, to the least possible, reduction in the sound pressure from the diaphragm due to the size reduction of the back space.

### BRIEF DESCRIPTION OF THE DRAWINGS

FIG. 1 is a plan view of a vehicle-mounted loudspeaker according to an embodiment of the present disclosure;

FIG. 2 is a front view of a vehicle-mounted loudspeaker according to an embodiment of the present disclosure;

FIG. 3 is a longitudinal cross-section of the vehicle-mounted loudspeaker shown in FIG. 1 cut along a line III-III;

FIG. 4 is a transverse cross-section of the vehicle-mounted loudspeaker shown in FIG. 1 cut along a line IV-IV; and

FIG. 5 shows line graphs comparing sound pressure level of a diaphragm and impedance between a loudspeaker of an embodiment of the present disclosure and a loudspeaker of a comparative example.

### DETAILED DESCRIPTION OF THE DISCLOSURE

### <Structure of Vehicle-Mounted Loudspeaker 1>

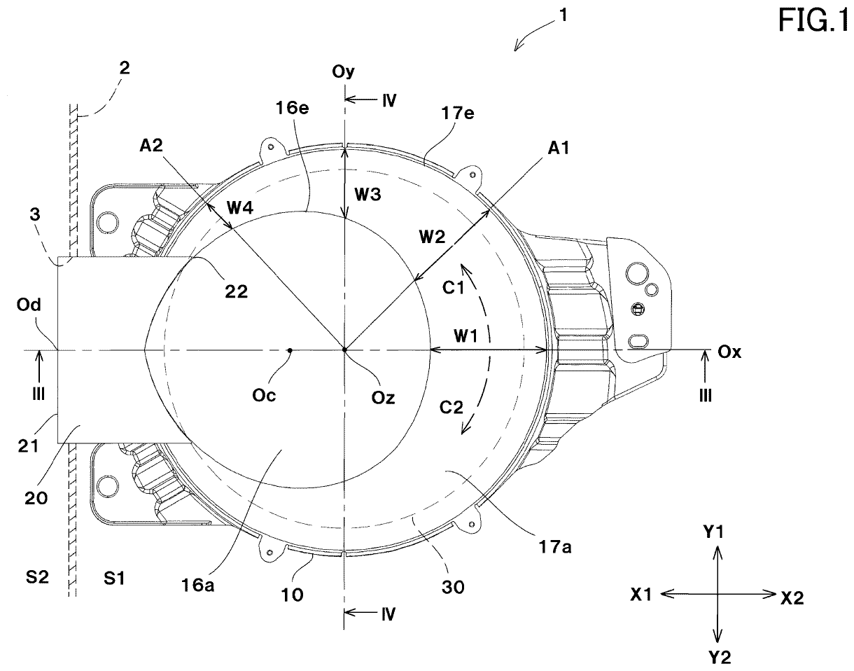

FIGS. 1 to 4 show a vehicle-mounted loudspeaker 1 according to an embodiment of the present disclosure. FIGS. 1 to 3 show a partition wall 2 of a vehicle, such as an automobile or the like, and a fitting hole 3 is opened in the partition wall 2. Regarding the partition wall 2 as a boundary, the space on the right side in the drawing is an inner space, which is a vehicle interior space S1 communicating with a living space in the vehicle. Regarding the partition wall 2 as a boundary, the space on the left side in the drawing is an outer space, which is a vehicle exterior space S2 communicating with the outside of the vehicle. The vehicle-mounted loudspeaker 1 has a case 10 that is integrated with a duct 20. The case 10 is installed in the vehicle interior space S1, and sound pressure generated when a diaphragm provided in the case 10 vibrates is applied to the vehicle interior space S1. An end of the duct 20 is fitted within the fitting hole 3 formed in the partition wall 2, and an opening 21 is opened to the vehicle exterior space S2 outside the partition wall 2.

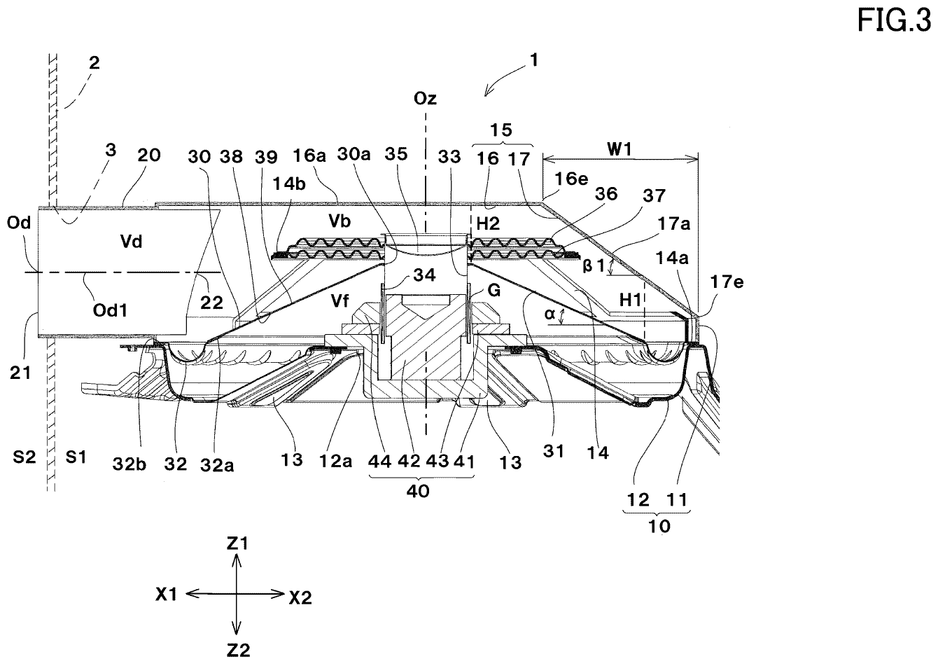

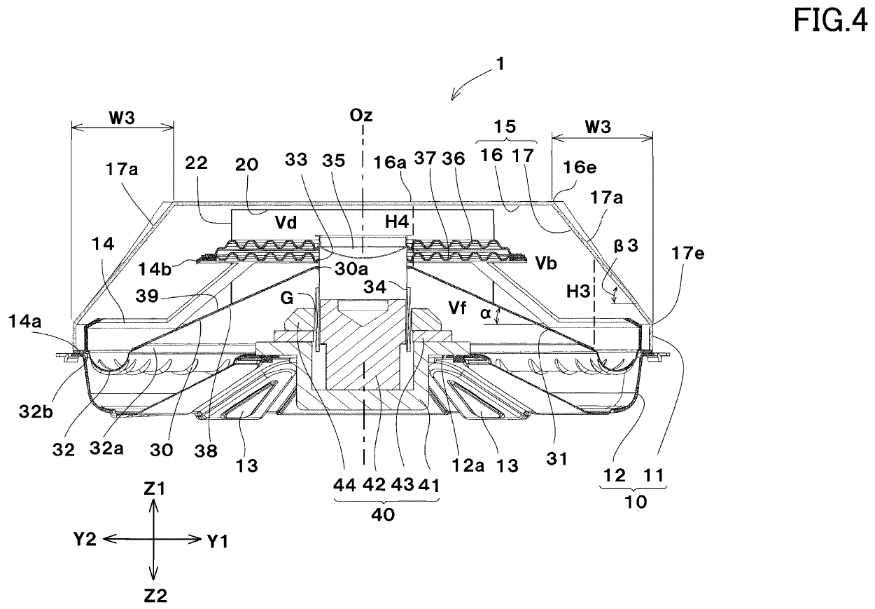

As shown in FIGS. 3 and 4, the vehicle-mounted loudspeaker 1 includes a diaphragm 30 provided in the case 10. An imaginary line extending in the vibration direction of the diaphragm 30 through the center of the diaphragm 30 is a center line Oz of vibration. The Z1-Z2 direction is the vertical direction parallel with the center line Oz of vibration, and is the vibration direction of the diaphragm 30. The Z1 direction is the upward direction and the Z2 direction is the downward direction. The Z2 direction is the direction in which sounds are emitted into the vehicle interior space S1 when the diaphragm 30 vibrates. FIG. 1 shows a longitudinal center line ox orthogonal to the center line Oz of vibration and including the center line Oz of vibration and an opening center Od of the opening 21 of the duct 20. The X1 direction is a forward direction along the longitudinal center line Ox and is the direction in which the back-space sound pressure is exhausted from the opening 21 of the duct 20 toward the vehicle exterior space S2. The X2 direction is a backward direction and is a direction toward the interior of the case 10. FIG. 1 shows a transverse center line Oy orthogonal to the longitudinal center line Ox by crossing the longitudinal center line Ox at the center line Oz of vibration. The Y1 direction along the transverse center line Oy is the leftward direction and the Y2 direction is the rightward direction.

A plane including the center line Oz of vibration, the opening center Od of the duct 20, and the longitudinal center line Ox is a longitudinal cross-section, and FIG. 3 is a longitudinal cross-sectional view of the case 10 and the duct 20 cut along the longitudinal cross-section. A plane including the center line Oz of vibration and the transverse center line Oy and orthogonal to the longitudinal cross-section is a transverse cross-section. FIG. 4 is a cross-sectional view of the case cut along the transverse cross-section.

The case 10 of the vehicle-mounted loudspeaker 1 shown in FIGS. 1 to 4 is a die-cast molding of a metal material, or an injection molding of a reinforced plastic. The case 10 is composed of an upper case 11 and a lower case 12 that are vertically assembled. The duct 20 is provided in front (on the X1 direction side) of the upper case 11. The duct 20 is integrally molded with the upper case 11. The duct 20 may be molded as a separate body from the upper case 11 and joined with the upper case 11. The duct 20 has a uniform opening cross-sectional area in the forward-backward direction (X direction). However, the duct 20 may have a shape in which the opening cross-sectional area gradually decreases toward the opening 21 (in the X1 direction). As shown in FIGS. 3 and 4, the lower case 12 has a plurality of sounding holes 13. A support frame 14 is provided inside the case 10. An outer periphery 14a of the support frame 14 is sandwiched between the upper case 11 and the lower case 12 from above and below.

As shown in FIGS. 3 and 4, the diaphragm 30 is provided inside the case 10. The diaphragm 30 has a circular (true circular or elliptical) shape when seen in a plane perpendicular to the center line Oz of vibration (when projected on the plane), and has a tapered part (cone part) 31 that tapers inward in the case 10 (toward the ceiling of the upper case 11) toward the center line Oz of vibration. A surface of the diaphragm 30 facing downward (in the Z2 direction) is an outer surface 38. When the diaphragm 30 vibrates, sound pressure, which becomes a sound, is applied from the outer surface 38 to the vehicle interior space S1 through the sounding holes 13 of the lower case 12. A surface of the diaphragm 30 facing upward (in the Z1 direction) is an inner surface 39, and the inner surface 39 faces the interior of the case 10.

An edge member 32 is joined to the outer periphery of the diaphragm 30. The edge member 32 has a semicircular cross-sectional shape and a ring-like shape when projected on a plane. The upper case 11 and the lower case 12 are fixed by screws in a state in which an inner periphery 32a of the edge member 32 is adhesively joined and fixed on the outer periphery of the diaphragm 30, and an outer periphery 32b of the edge member 32 is sandwiched, together with the outer periphery 14a of the support frame 14, between the outer peripheries of the upper case 11 and the lower case 12.

As shown in FIGS. 3 and 4, a center hole 30a is formed in the center of the diaphragm 30, and a cylindrical bobbin 33 is fixed in the center hole 30a. A voice coil 34 is wound around and fixed on the outer periphery of a lower part of the bobbin 33. The upper opening of the bobbin 33 is closed with a cap 35. Damper members 36 and 37 are provided in the case 10. Each of the damper members 36 and 37 has a ring shape when projected on a plane, and has a corrugated shape when seen in the longitudinal cross-section shown in FIG. 3. The outer peripheries of the damper members 36 and 37 are adhesively joined and fixed to an upper end support part 14b of the support frame 14, and the inner peripheries of the damper members 36 and 37 are adhesively joined and fixed to the outer peripheral surface of the bobbin 33. The diaphragm 30 is supported by the edge member 32 and the damper members 36 and 37, and can vibrate vertically along the center line Oz of vibration due to elastic deformation of the edge member 32 and the damper members 36 and 37.

As shown in FIGS. 3 and 4, a support hole 12a is opened in the center of the lower case 12, and a magnetic circuit 40 is fixed to the support hole 12a. The magnetic circuit 40 includes a lower yoke 41, a center yoke 42 fixed on the upper side of the lower yoke 41 and positioned inside the bobbin 33, a ring-shaped magnet 43 fixed on the outer periphery of the lower yoke 41 and positioned outside the bobbin 33, and a ring-shaped upper yoke 44 fixed on the upper side of the magnet 43. The lower yoke 41, the center yoke 42, and the upper yoke 44 are formed of a magnetic material. A magnetic gap G is formed between the outer peripheral surface of the center yoke 42 and the inner peripheral surface of the upper yoke 44, and the voice coil 34 provided on the outer periphery of the lower part of the bobbin 33 is positioned in the magnetic gap G.

In the magnetic circuit 40, a magnetic flux crossing the magnetic gap G is formed. A vibration force in the vertical direction is applied to the diaphragm 30 via the voice coil 34 due to an electromagnetic force caused by a voice current flowing through the voice coil 34 positioned in the magnetic gap G and the magnetic flux crossing the voice coil 34 in the magnetic gap G. The magnetic circuit 40 and the voice coil 34 constitute a “magnetic drive part”.

The interior of the case 10 is almost completely partitioned into upper and lower spaces by the diaphragm 30, the edge member 32, and the cap 35 covering the upper part of the bobbin 33. The lower space partitioned by the diaphragm 30, the edge member 32, and the cap 35 is an outer space Vf, and the outer space Vf communicates with the vehicle interior space S1 through the sounding holes 13 of the lower case 12. The upper space partitioned by the diaphragm 30, the edge member 32, and the cap 35 is a back space Vb. The back space Vb is a space enclosed by the diaphragm 30, the edge member 32, and the cap 35, and the inner surface of the upper case 11, i.e., an inner wall surface 15 of the case 10. The back space Vb communicates only with an inner space Vd of the duct 20.

As shown in FIGS. 1 to 4, in the vehicle-mounted loudspeaker 1, the case 10 is provided in the vehicle interior space S1. When the diaphragm 30 vibrates, air vibration is applied by the outer surface 38 of the diaphragm 30 to the outer space Vf, and the air vibration becomes sound pressure, which acts on the vehicle interior space S1 through the plurality of sounding holes 13 formed in the lower case 12, thereby providing a reproduced sound in the vehicle interior space S1. When the diaphragm 30 vibrates, a back pressure having a phase opposite to that of the sound pressure acting on the outer space Vf is applied to the back space Vb in the case 10 by the inner surface 39 of the diaphragm 30. Since this back pressure is applied to the vehicle exterior space S2 through the opening 21 of the duct 20, the back pressure is not heard in the vehicle interior space S1.

### <Shape of Back Space Vb>

As shown in FIGS. 3 and 4, the inner wall surface of the case 10 facing the diaphragm 30, that is, the inner wall surface 15 forming the back space Vb, includes a flat inner wall surface 16 perpendicular to the center line Oz of vibration and facing the inner surface 39 of the diaphragm 30, and a tapered inner wall surface 17 continuous with the outer periphery of the flat inner wall surface 16 and inclined in the same direction as that in which the tapered part 31 of the diaphragm 30 is inclined. As shown in FIGS. 3 and 4, the upper case 11 has a uniform thickness. Therefore, the appearance of the case 10 when seen in the plan view of FIG. 1 includes: a flat region 16a that has almost the same shape and area as those of the flat inner wall surface 16, which is the inner surface of the flat region 16a; and a tapered region 17a that has almost the same shape and area as those of the tapered inner wall surface 17, which is the inner surface of the tapered region 17a.

As shown in FIG. 1, the planar shapes of the flat region 16a and the flat inner wall surface 16 are almost circular, and their centroid Oc is located on the longitudinal center line Ox and located closer to the duct 20 than the center line Oz of vibration is. As a result, when seen in the plan view of FIG. 1 (when projected on a plane perpendicular to the center line Oz of vibration), the width dimension W of the tapered region 17a and the tapered inner wall surface 17 vary depending on the positions. The width dimension W is the distance, in the radial direction centering on the center line Oz of vibration, between an outer peripheral edge 16e of the flat region 16a and the flat inner wall surface 16 and an outer peripheral edge 17e of the tapered region 17a and the tapered inner wall surface 17 when seen in the plan view.

As shown in FIG. 1, the width dimension W on the longitudinal center line Ox, i.e., the width dimension W in the longitudinal cross-section shown in FIG. 3, is defined as W1, and the width dimension W on the transverse center line Oy, i.e., the width dimension W in the transverse cross-section shown in FIG. 4, is defined as W3. FIG. 1 shows a selecting line A1 extending in the radial direction centering on the center line Oz of vibration at an angular position that is half the angle formed by the longitudinal center line Ox and the transverse center line Oy and that is on the back side of the transverse center line Oy (in the X2 direction). The width dimension W on the selecting line A1, i.e., the width dimension W of a selected cross-section including the selecting line A1 and the center line Oz of vibration, is defined as W2. FIG. 1 shows a selecting line A2 extending in the radial direction centering on the center line Oz of vibration at an angular position that is half the angle formed by the longitudinal center line Ox and the transverse center line Oy and that is on the front side of the transverse center line Oy (in the X1 direction). The width dimension W on the selecting line A2, i.e., the width dimension W in a selected cross-section including the selecting line A2 and the center line Oz of vibration, is defined as W4.

The width dimension W3 of the tapered region 17a and the tapered inner wall surface 17 on the transverse center line Oy is narrower than the width dimension W1 thereof on the longitudinal center line Ox and at a position farther from the duct 20 than the center line Oz of vibration is. The width dimension W2 at the position of the selecting line A1 is narrower than the width dimension W1 and wider than the width dimension W3. The width dimension W4 at the position of the selecting line A2 is narrower than the width dimension W3. The width dimension W gradually decreases from W1 at the position of the longitudinal center line Ox to W2 at the position of the selecting line A1 and to W3 at the transverse center line Oy along the counterclockwise circumferential locus C1 about the center line Oz of vibration. Furthermore, the width dimension W gradually decreases from W3 at the transverse center line Oy to W4 at the position of the selecting line A2 along the circumferential locus C1 toward a boundary 22 between the case 10 and the duct 20. In FIG. 1, the shape of the case 10 is a line symmetric shape in the transverse direction (Y1-Y2 direction) with respect to the longitudinal center line Ox. Therefore, also along a clockwise circumferential locus C2 about the center line Oz of vibration, the width dimension W gradually decreases in order of W1, W2, W3, and W4 toward the boundary 22 between the case 10 and the duct 20.

As shown in FIGS. 3 and 4, the inclination angle α of the tapered part 31 of the diaphragm 30 with respect to a plane perpendicular to the center line Oz of vibration is uniform at any position of the tapered part 31. On the other hand, because the width dimension W of the tapered region 17a and the tapered inner wall surface 17 of the case 10 when seen in a plane vary as described above, the inclination angle β3 of the tapered inner wall surface 17 at the position in the cross-section shown in FIG. 4 is larger than the inclination angle β1 of the tapered inner wall surface 17 of the case 10 at the position in the longitudinal cross-section shown in FIG. 3 with respect to a horizontal plane. Therefore, the opening angle (β3-α) between the inner surface 39 of the tapered part 31 and the inner wall surface 15 (tapered inner wall surface 17) of the case 10 at the position in the transverse cross-section is larger than the opening angle (β1-α) between the inner surface 39 of the tapered part 31 and the inner wall surface 15 (tapered inner wall surface 17) of the case 10 at the position in the longitudinal cross-section. The opening angle (β-α) at the position in the selected cross-section including the center line Oz of vibration and the selecting line A1 is larger than the opening angle (β-α) at the position in the longitudinal cross-section and smaller than the opening angle (β-α) at the position in the transverse cross-section. The opening angle (β-α) at the position in the selected cross-section including the center line Oz of vibration and the selecting line A2 is larger than the opening angle (β-α) at the position in the transverse cross-section. That is, the opening angle (β-α) gradually increases from the position in the longitudinal cross-section to the position in the transverse cross-section along the circumferential locus C1 and the circumferential locus C2, and further gradually increases from the position in the transverse cross-section to the boundary 22 between the case 10 and the duct 20.

As shown in FIG. 1, the width dimension W of the tapered region 17a and the tapered inner wall surface 17 is varied along the circumferential loci C1 and C2, and along with this, the opening angle (β-α) between the inner surface 39 of the tapered part 31 and the inner wall surface 15 (tapered inner wall surface 17) of the case 10 at the positions in the respective cross-sections varies along the circumferential loci C1 and C2. Therefore, the area of a counter space in which the inner surface 39 of the tapered part 31 of the diaphragm 30 and the inner wall surface 15 of the case 10 are counter to each other in the vertical direction (Z1-Z2 direction) in the transverse cross-section shown in FIG. 4 is larger than the area of the counter space in which the inner surface 39 of the tapered part 31 and the inner wall surface 15 of the case 10 are counter to each other in the vertical direction in the longitudinal cross-section shown in FIG. 3. An outer peripheral vertical line H1 extending in the vertical direction from the outer periphery of the diaphragm 30 and an inner peripheral vertical line H2 extending in the vertical direction from the inner periphery of the diaphragm 30 are shown in FIG. 3. The area of the counter space in the longitudinal cross-section is the area of the counter space enclosed by the inner surface 39 of the tapered part 31 of the diaphragm 30, the tapered inner wall surface 17 of the case 10, the outer peripheral vertical line H1, and the inner peripheral vertical line H2. The area of the counter space in the transverse cross-section is the area of the counter space enclosed by the inner surface 39 of the tapered part 31 of the diaphragm 30, the tapered inner wall surface 17 of the case 10, an outer peripheral vertical line H3, and an inner peripheral vertical line H4.

The area of the counter space in the selected cross-section including the selecting line A1 is larger than the area of the counter space in the longitudinal cross-section and smaller than the area of the counter space in the transverse cross-section, and the area of the counter space in the selected cross-section including the selecting line A2 is larger than the area of the counter space in the transverse cross-section. The area (inner volume) of the back space Vb in respective cross-sections including the center line Oz of vibration is the smallest at the position that is opposite to the location of the duct 20 with respect to the center line Oz of vibration, and gradually increases from that position toward the boundary 22 between the case 10 and the duct 20 along the circumferential locus C1 and the circumferential locus C2.

### <Acoustic Effect>

In the vehicle-mounted loudspeaker 1, the diaphragm 30 vibrates in the vertical direction (Z1-Z2 direction) due to an electromagnetic force generated by a voice current flowing through the voice coil 34 and the magnetic field crossing the voice coil 34 in the magnetic gap G of the magnetic circuit 40. Sound pressure applied to the outer space Vf by the outer surface 38 of the diaphragm 30 forms a reproduced sound, which is provided to the vehicle interior space S1 from the sounding holes 13 of the lower case 12. When the diaphragm 30 vibrates, a back pressure is applied to the back space Vb by the inner surface 39, and this back pressure is applied to the vehicle exterior space S2 from the opening 21 of the duct 20. Although the phases of the sound pressure acting on the outer space Vf and the back pressure acting on the back space Vb are opposite, the sound pressure applied to the vehicle interior space S1 and the back pressure do not interfere owing to the baffle function of the partition wall 2.

In relation with the frame structure of the vehicle, there is a limit to enlarging the fitting hole 3 in the partition wall 2. In addition, if the fitting hole 3 is enlarged and the opening area of the opening 21 of the duct 20 is enlarged, moisture and dust may enter the duct 20. Therefore, the opening area of the opening 21 of the duct 20 cannot be enlarged very much. Therefore, when the diaphragm 30 vibrates, the difficulty for air to move in the duct 20 becomes a load mass (md). When the diaphragm 30 vibrates, the back pressure acting on the back space Vb moves toward the inner space Vd of the duct 20. Here, the difficulty for air to move in the back space Vb toward the duct 20 also becomes a back pressure load mass (mb). Since the load mass (md) and the back pressure load mass (mb) are added to the mass (mmv) of the vibration system composed of the diaphragm 30, the bobbin 33, the voice coil 34, the edge member 32, the damper members 36, 37, and the like, the presence of the load masses (md) and (mb) substantially increases the mass of the vibrating part including the diaphragm 30.

In the back space Vb of the vehicle-mounted loudspeaker 1 of the embodiment, the counter space that is opposite to the location of the duct 20 across the center line Oz of vibration, that is, the counter space between the outer peripheral vertical line H1 and the inner peripheral vertical line H2 in the longitudinal cross-sectional view of FIG. 3, is the narrowest, and the area of the counter space appearing in the respective cross-sections including the center line Oz of vibration gradually increases along the circumferential loci C1 and C2. When the diaphragm 30 vibrates, a back pressure, in which the coarseness and denseness of air periodically appears is generated in the counter space between the outer peripheral vertical line H1 and the inner peripheral vertical line H2 in the back space Vb, and this back pressure attempts to advance toward the duct 20 along the circumferential loci C1 and C2. When the back pressure moves from the longitudinal cross-section shown in FIG. 3 along the directions of the circumferential loci C1 and C2, the area of the counter space in the cross-section to which the back pressure has moved is larger. Therefore, even though the coarseness and denseness of air that has moved from the longitudinal cross-section is added to the coarseness and denseness of air in that cross-section, increase in the air pressure per unit area of the counter space appearing in that cross-section can be as small as possible. Although the back pressure is directed toward the duct 20 along the circumferential locus C1 and the circumferential locus C2, since the area of the counter space appearing in the respective cross-sections toward the duct 20 gradually increases, the accumulation of the pressure due to coarseness and denseness of air in the counter space appearing in the respective cross-sections can be minimized, which acts to reduce the back pressure load mass (mb).

As a comparative example, assume a loudspeaker in which the area of the counter space between the tapered part 31 of the diaphragm 30 and the inner wall surface 15 of the case 10 appearing in the cross-sections at all positions along the circumferential loci C1 and C2 toward the duct 20 is uniform. In the loudspeaker of this comparative example, when a back pressure, which is coarseness and denseness of air generated in the counter space at the position farthest from the duct 20, moves in the direction toward the duct 20 along the circumferential loci C1 and C2, the area of the counter space in the reached cross-section is the same, so the density of the back pressure becomes twice as large conceptually. When the back pressure moves further, it becomes four times and eight times as large, and the moving load (local pressure) of the pressure moving toward the duct 20 in the back space Vb accumulates and becomes extremely large.

In the vehicle-mounted loudspeaker 1 of the embodiment, accumulation of such a moving difficulty (resistance against pressure movement) as in the comparative example can be reduced for the movement of air (movement of pressure) flowing in the back space Vb toward the duct 20. When the vehicle-mounted loudspeaker 1 of the embodiment is compared with the loudspeaker of the comparative example with the inner volume of the back space Vb set to the same value between the vehicle-mounted loudspeaker 1 of the embodiment and the loudspeaker of the comparative example, the vehicle-mounted loudspeaker 1 of the embodiment can reduce the back pressure load mass (mb) representing the moving difficulty of air moving toward the duct 20 more than the loudspeaker of the comparative example can. Therefore, in the vehicle-mounted loudspeaker 1 of the embodiment, the vibration load on the diaphragm 30 can be reduced, and the output sensitivity of the loudspeaker can be increased as much as possible.

As shown in FIGS. 1 to 3, the vehicle-mounted loudspeaker 1 of the embodiment in which the area of the counter space in the back space Vb is gradually increased toward the duct 20 can exhibit an especially effective effect in a use in which the case 10 is installed in the vehicle interior space S1 and the opening 21 of the duct 20 is opened to the vehicle exterior space S2.

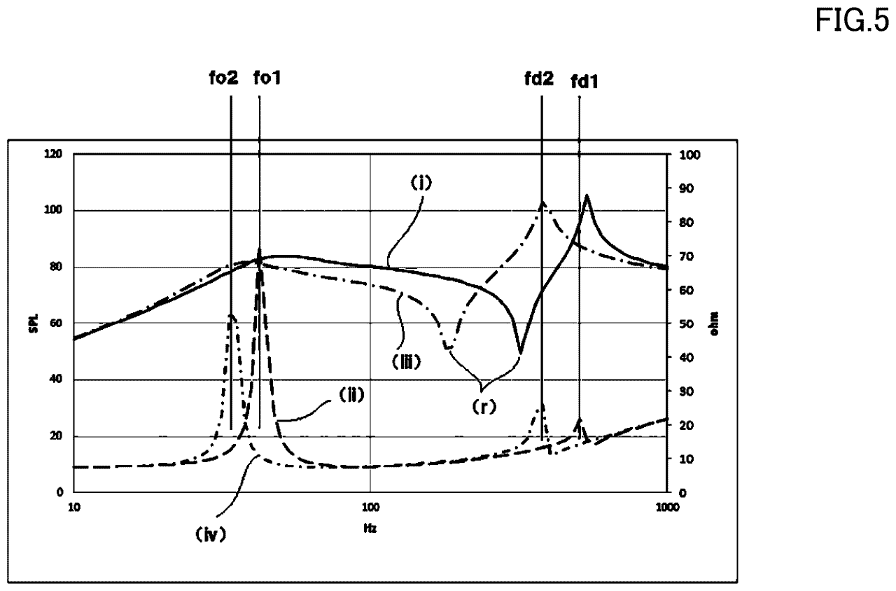

FIG. 5 shows the characteristics of the loudspeaker 1 of the embodiment of the present disclosure compared with the characteristics of the loudspeaker of the comparative example. As described above, the loudspeaker of the comparative example has a structure in which the area of the counter space between the tapered part 31 of the diaphragm 30 and the inner wall surface 15 of the case 10, which appears in the cross-sections at all positions along the circumferential loci C1 and C2 toward the duct 20, is uniform. In FIG. 5, the horizontal axis shows the frequency (Hz), the vertical axis on the left side shows the sound pressure level (dB) from the diaphragm, and the vertical axis on the right side shows the impedance (Ω) of the loudspeaker. In FIG. 5, (i) shows the frequency characteristics of the sound pressure level applied by the diaphragm 30 to the outer space Vf in the case 10 of the loudspeaker 1 of the embodiment of the present disclosure, (ii) shows the impedance characteristics of the loudspeaker 1 of the embodiment, (iii) shows the frequency characteristics of the sound pressure level applied by the diaphragm to the outer space Vf in the case of the loudspeaker of the comparative example, and (iv) shows the impedance characteristics of the loudspeaker of the comparative example. “fo1” is the lowest resonance frequency of the vibration system composed of the diaphragm 30, the bobbin 33, the voice coil 34, the edge member 32, the damper members 36 and 37, and the like, and “fd1” is the resonance frequency of the Helmholtz resonator composed of the back space Vb and the duct 20 in the loudspeaker 1 of the embodiment of the present disclosure. “fo2” is the lowest resonance frequency of the vibration system in the comparative example, and “fd2” is the resonance frequency of the Helmholtz resonator composed of the back space and the duct in the comparative example.

In the loudspeaker 1 of the embodiment and the loudspeaker of the comparative example, the Helmholtz resonator is composed of the case and the duct. The sound pressure level that is output from the diaphragm undergoes decrease (r) in the frequency band near the resonance frequencies “fd1” and “fd2”. This is because, near the resonance frequency of the Helmholtz resonator, the air in the duct 20 resonates and vibrates with a large amplitude, which increases the inner pressure in the back space Vb and restricts the amplitude of the diaphragm 30. The vehicle-mounted loudspeaker 1 is used as a woofer, and the frequency band of use is approximately 150 Hz or lower. When the decrease (r) in the sound pressure level appears in or near this frequency band of use, the acoustic output applied to the vehicle interior space S1 is significantly reduced in the band that is from, for example, 80 Hz to 150 Hz.

Therefore, by setting the resonance frequency of the Helmholtz resonator composed of the back space Vb in the case and the inner space Vd of the duct 20 in a high frequency band, it is possible to shift the decrease (r) in the sound pressure level to a region higher than the frequency band of use as a woofer. It is possible to increase the resonance frequency by widening the opening area of the duct and reducing the volume of the back space Vb. However, as described above, when it comes to a vehicle-mounted loudspeaker, there is a limit to increasing the opening area of the duct. Therefore, it is necessary to reduce the inner volume of the back space Vb in order to increase the resonance frequency. When reducing the inner volume of the back space Vb is by maintaining the area of the diaphragm at equal to or greater than a certain value, it is necessary to reduce the counter distance between the diaphragm and the inner wall of the case in the vertical direction. In the loudspeaker of the comparative example, the area of the vertical counter space between the tapered part of the diaphragm and the inner wall surface of the case, which appears in the cross-sections at all positions along the circumferential loci C1 and C2 toward the duct, is uniform. Therefore, the cumulative value of the back pressure load mass (mb), which represents the difficulty for the air to move in the back space Vb toward the duct, is significantly large, and the acoustic output applied by the diaphragm to the vehicle interior space S1 is reduced, which means a significant reduction in the sensitivity as a loudspeaker.

In the loudspeaker of the comparative example, the volume of the back space Vb of the case cannot be reduced. Therefore, it is impossible to set the resonance frequency “fd2” of the Helmholtz resonator in a very high region, and the decrease (r) in the sound pressure level output by the diaphragm tends to appear close to the frequency band of use as a woofer or appear in the frequency band of use as shown by (iii) in FIG. 5. Furthermore, the cumulative value of the back pressure load mass (mb) is large in the loudspeaker of the comparative example. Therefore, as shown by (iii), the problem arises that it is impossible to obtain a high sound pressure level in the frequency band of use that is lower than the frequency at which the decrease (r) in the sound pressure level occurs.

In the vehicle-mounted loudspeaker 1 of the embodiment, even when the inner volume of the back space Vb is reduced in order to set the resonance frequency “fd1” of the Helmholtz resonator in a high range, it is possible to inhibit accumulation of the back pressure load mass (mb) representing the difficulty for air to move in the back space Vb toward the duct by gradually increasing the area of the back space Vb in the respective cross-sections including the center line Oz of vibration toward the duct 20 along the circumferential loci C1 and C2. Therefore, as shown by (i) in FIG. 5, by reducing the inner volume of the back space Vb in the case 10, it is possible to set the resonance frequency “fd1” of the Helmholtz resonator in a frequency band higher than that of the loudspeaker of the comparative example, and to shift the decrease (r) in the sound pressure level to a band higher than the upper limit of the frequency band of use as a woofer, which is 150 Hz. Moreover, since the cumulative value of the back pressure load mass (mb) representing the difficulty for air to move in the back space Vb toward the duct is small, it is possible to obtain sound pressures from the diaphragm 30 with a good sensitivity in a wide frequency band that is 150 Hz or lower as shown by the line (i).

Moreover, as shown by (i) in FIG. 5, by setting the lowest resonance frequency “fo1” of the vibration system composed of the diaphragm 30, the bobbin 33, the voice coil 34, the edge member 32, the damper members 36 and 37, and the like in a frequency band that is lower than the resonance frequency “fd1” of the Helmholtz resonator and near the frequency band of use as a woofer, it is possible to facilitate vibration of the diaphragm 30 in the frequency band of use, and to increase the sound pressure level.

### Modification Example

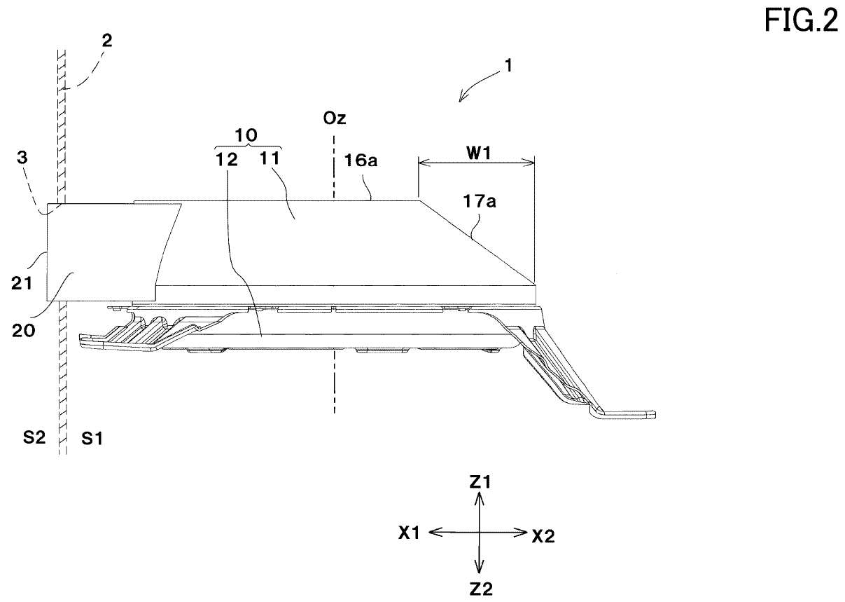

As shown in FIGS. 2 and 3, in the vehicle-mounted loudspeaker 1 of the embodiment, the center line Od1 of the duct 20 extends in the direction orthogonal to the center line Oz of vibration. However, the duct may be connected to the case 10 at a position that is offset from the center line Oz of vibration with the center line Od1 of the duct 20 extending in the vertical direction (Z1-Z2 direction).

In addition, the vehicle-mounted loudspeaker 1 may be used in a manner where the case 10 is installed in the vehicle exterior space S2, and the sound pressure that forms a reproduced sound is applied from the opening 21 of the duct 20 into the vehicle interior space S1. In this case as well, by using the case 10 forming the back space Vb of the embodiment, it is possible to reduce the back pressure load mass (mb), which represents the difficulty for the air to move in the back space Vb toward the duct 20, and to increase the vibration sensitivity of the diaphragm 30.

What is claimed is:

1. A vehicle-mounted loudspeaker, comprising:
a case having a duct;
a diaphragm; and
a magnetic drive part configured to drive the diaphragm, the diaphragm and the magnetic drive part being installed inside the case,
wherein the diaphragm has an outer surface that applies sound pressure to outside the case and an inner surface facing an interior of the case,
the diaphragm includes a tapered part tapering inward in the case toward a center line of vibration extending in a vibration direction while passing through a center line of the diaphragm,
a back space enclosed by the inner surface of the diaphragm and an inner wall surface of the case and leading to an interior of the duct is formed inside the case, and
when a cross-section including the center line of vibration and a center of an opening of the duct is defined as a longitudinal cross-section, and a cross-section including the center line of vibration and orthogonal to the longitudinal cross-section is defined as a transverse cross-section, an area of a space in which the tapered part and the inner wall surface face each other is larger when seen in the transverse cross-section than when seen in the longitudinal cross-section, the space being a space at a position opposite to a location of the duct with respect to the center line of vibration in the longitudinal cross-section, and the space being a space at a position on a path along a circular circumference centering on the center line of vibration in the transverse cross-section.

2. The vehicle-mounted loudspeaker according to claim 1,
wherein the area when seen in cross-sections including the center line of vibration at respective positions on the path along the circular circumference centering on the center line of vibration gradually increases from the position in the longitudinal cross-section toward the position on the path in the transverse cross-section.

3. The vehicle-mounted loudspeaker according to claim 2,
wherein the area when seen in the cross-sections including the center line of vibration at the respective positions on the path along the circular circumference centering on the center line of vibration gradually increases from the position on the path in the transverse cross-section toward a boundary between the case and the duct.

4. The vehicle-mounted loudspeaker according to claim 1,
wherein an opening angle between the inner surface of the tapered part and the inner wall surface of the case is larger when seen in the transverse cross-section than when seen in the longitudinal cross-section, the opening angle being an opening angle at the position opposite to the location of the duct with respect to the center line of vibration in the longitudinal cross-section, and the opening angle being an opening angle at the position on the path along the circular circumference centering on the center line of vibration in the transverse cross-section.

5. The vehicle-mounted loudspeaker according to claim 4,
wherein the opening angle when seen in cross-sections including the center line of vibration at respective positions on the path along the circular circumference centering on the center line of vibration gradually increases from the position in the longitudinal cross-section toward the position on the path in the transverse cross-section.

6. The vehicle-mounted loudspeaker according to claim 5,
wherein the opening angle when seen in the cross-sections including the center line of vibration at the respective positions on the path along the circular circumference centering on the center line of vibration gradually increases from the position on the path in the transverse cross-section toward a boundary between the case and the duct.

7. The vehicle-mounted loudspeaker according to claim 4,
wherein the inner wall surface of the case includes: a flat inner wall surface orthogonal to the center line of vibration and facing the inner surface of the diaphragm; and a tapered inner wall surface positioned on an outer periphery of the flat inner wall surface and inclined in a same direction as a direction in which the tapered part of the diaphragm is inclined, and
a width dimension of the tapered inner wall surface when seen in a plane orthogonal to the center line of vibration is smaller at the position on the path in the transverse cross-section than at the position in the longitudinal cross-section.

8. The vehicle-mounted loudspeaker according to claim 7,
wherein the width dimension gradually decreases along the path along the circular circumference centering on the center line of vibration from the position in the longitudinal cross-section toward the position on the path in the transverse cross-section.

9. The vehicle-mounted loudspeaker according to claim 8,
wherein the width dimension gradually decreases along the path along the circular circumference from the position on the path in the transverse cross-section toward a boundary between the case and the duct.

10. The vehicle-mounted loudspeaker according to claim 7,
wherein a centroid of the flat inner wall surface when seen in the plane is located closer to the duct than the center line of vibration is.

11. The vehicle-mounted loudspeaker according to claim 1,
wherein the duct is opened to an exterior space bounded by a partition wall, and sound pressure is applied by the diaphragm to an interior space bounded by the partition wall.
